(19) United States
(12) Patent Application Publication
(10) Pub. No.: US 2014/0248583 A1
(43) Pub. Date: Sep. 4, 2014

(54) SUPPORT MECHANISM

(71) Applicant: EdMiDent, LLC, Los Angeles, CA (US)

(72) Inventor: Edwin Rostami, Yerevan (AM)

(21) Appl. No.: 14/197,137

(22) Filed: Mar. 4, 2014

Related U.S. Application Data
(60) Provisional application No. 61/772,361, filed on Mar. 4, 2013.

(51) Int. Cl. A61C 8/00

(52) U.S. Cl. CPC A61C 8/0077; A61C 8/0012; A61C 8/0068
USPC 433/173

(57) ABSTRACT

Disclosed is an apparatus and a method for supporting an intraosseous implant that facilitates and prevents further resorption at an implantation site by reducing parafunctional pressures experienced at the implantation site, transferring and transmitting functional pressures to the implantation site without an increase in size of an intraosseous implant and without osteosynthesis.

### CROSS-REFERENCE TO RELATED APPLICATIONS

This application claims the benefit of priority of the co-pending U.S. Utility Provisional Patent Application No. 61/772,361, filed Mar. 4, 2013, titled “Support Mechanism,” the entire disclosures of which application is expressly incorporated by reference in its entirety herein.

It should be noted that where a definition or use of a term in the incorporated patent application is inconsistent or contrary to the definition of that term provided herein, the definition of that term provided herein applies and the definition of that term in the incorporated patent application does not apply.

### BACKGROUND OF THE INVENTION

1. Field of the Invention

The present invention relates to the general field of implants for use in oral and maxillofacial surgery and, more particularly to a support mechanism for intraosseous dental implants universally applicable at an implantation site on the mandible or the maxilla.

2. Description of Related Art

It is conventional and well known that intraosseal dental implants are the best method of rehabilitation for partially or completely edentulous jaw. However, in some cases the required necessary conditions for intraosseal dental implant installations are not in place (e.g., lack of healthy bone tissue), which makes implantation of dental implants impossible or extremely complicated.

If the required necessary conditions for intraosseal dental implant installations are not in place, then in general, additional surgical procedures must be performed in order to meet the required necessary conditions. Non-limiting examples of such surgical procedures may include osteosynthesis (e.g., bone grafting or bone reconstruction), sinus lift, etc. to replace loss of bone mass due to bone resorption. Regrettably, a majority of such surgical procedures are complicated with numerous significant negative side-effects for patients, including:
physical and psychological trauma and medical risk
Additional financial liabilities
Extended treatment and healing periods
Age limits

Assuming that all the required necessary conditions for intraosseal dental implant installations are met, there are numerous additional challenges and complications arising during implantation and post implantation periods for intraosseal dental implants even for healthy bones, including:
Fracture of intraosseal dental implants, including fixtures, abutments, or screws thereof
Loosening of abutment screws of the intraosseal dental implants
Bone resorption in crestal bone
Periimplantitis
Delay of the intraosseal implant loading term (due to osteosynthesis)
Implant migration
In case of long-term impact of parafunctional and lateral forces, increased risk of implant loss, for example bruxism, clenching, etc.

An important reason for any of the above-mentioned complications are the functional and parafunctional pressures (or stresses) experienced by the intraosseal dental implant due to pressures caused by exerted forces, which are mainly concentrated on an upper part (about 3 to 5 mm) of the crestal bone area. The stress (or Pressure P) may be defined by P=F/S, where F is the exerted force and S is the surface area experiencing the exerted force F. It is obvious that pressure P (or stress) can be decreased by increasing the surface area S of an intraosseal dental implant by, for example, using larger intraosseal dental implants (in terms of girth and or length). Quite often, however, it is not possible to use larger size implants in general or without any additional surgical procedures (for example, osteosynthesis of bone due to bone resorption).

Accordingly, in light of the current state of the art and the drawbacks to current dental implants, a need exists for an apparatus that would increase a surface area experiencing exerted forces (functional or parafunctional) to reduce parafunctional stress on dental implants without requiring an increase in size or length of the dental implant itself. Further, a need exists for an apparatus that would be used with existing conventional dental implants (preferably intraosseous dental root-shape implants) that would facilitate and support osseointegration within an implantation site and would mechanically transfer and transmit functional pressures to the installation site of the dental implant in order to avoid disadvantageous restructuring of the bone in adherence to Wolff's law, i.e. biologic systems such as hard and soft tissues become distorted in direct correlation to the amount of stress imposed upon them. Further, a need exists for an apparatus that would facilitate the use of existing conventional dental implants (small or large) and their respective kits (e.g., surgical implantation tools) that would be universally applicable at the implantation site on the mandible or the maxilla even with substantial bone resorption and without requiring much, if any, osteosynthesis.

### BRIEF SUMMARY OF THE INVENTION

A non-limiting, exemplary aspect of an embodiment of the present invention provides an apparatus, comprising:
a plate with a first and second sides that includes:
at least one hole for coupling a device with the plate;
at least one aperture for securing the plate with a structure; and
at least one orifice for integration of the plate with the structure.

A non-limiting, exemplary aspect of an embodiment of the present invention provides a supporting foundation for an intraosseous dental implant support, comprising:
a plate that is adapted to be associated with an implantation site of an intraosseous implant on a mandible or a maxilla;
the plate includes:
at least one implant hole for receiving and securing the intraosseous implant;
at least one anchoring aperture for anchoring the plate onto the implantation site;
at least one integration orifice for facilitating and enhancing integration of the plate with the implantation site.

A non-limiting, exemplary aspect of an embodiment of the present invention provides an intraosseous dental implant, comprising:
a plate that is adapted to be associated with an implantation site on a mandible or a maxilla;
the plate includes:
at least one implant hole for receiving and securing the intraosseous dental implant;
at least one anchoring aperture for anchoring the plate onto the implantation site;
at least one integration orifice for facilitating and enhancing integration of the plate with the implantation site.

A non-limiting, exemplary aspect of an embodiment of the present invention provides a method for supporting intraosseous implants, comprising:
increasing a surface area of an implantation site; and
osseointegrating the increased implantation site surface area experiencing exerted forces to reduce parafunctional pressures while mechanically transferring and transmitting functional pressures to the implantation site without an increase in size of intraosseous implant and without osteosynthesis, thereby preventing further resorption at the implantation site.

A non-limiting, exemplary aspect of an embodiment of the present invention provides a method for supporting intraosseous implants, comprising:
providing a supporting foundation for an implantation site;
osseointegrating the supporting foundation;
wherein: osseointegrated supporting foundation reduces parafunctional pressures experienced at the implantation site while mechanically transferring and transmitting functional pressures to the implantation site without an increase in size of an intraosseous implant and without osteosynthesis, thereby preventing further resorption at the implantation site.

A non-limiting, exemplary aspect of an embodiment of the present invention provides a method for preventing further resorption at an implantation site, comprising:
reducing parafunctional pressures experienced at the implantation site; and
transferring and transmitting functional pressures to the implantation site without an increase in size of an intraosseous implant and without osteosynthesis.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment as “exemplary” is not necessarily to be construed as preferred or advantageous over other embodiments. In the drawings, like reference character(s) present corresponding part(s) throughout.

FIG. 1A is a non-limiting, exemplary overview illustration of one or more embodiments of an apparatus of the present invention with one or more conventional intraosseous dental implant fixtures, exemplarily illustrating universal applicability of one or more embodiments of the present invention at an implantation site on a jawbone (mandible or the maxilla);

FIGS. 1B to 1E are non-limiting, non-exhaustive, exemplary illustrations of various intraosseous dental implant procedures that may be practiced in accordance with one or more embodiments of the present invention;

FIG. 2A is a non-limiting, exemplary illustration of an embodiment of an apparatus in accordance with the present invention; and FIG. 2B to 2F are non-limiting, exemplary sectional profile illustrations of an embodiment (e.g., shown in FIGS. 2A and 2B) of an apparatus in accordance with the present invention.

FIGS. 3A to 3H are non-limiting, exemplary illustrations that progressively illustrate associating a plate with an implantation site in accordance with one or more embodiments of the present invention;

FIGS. 4A to 4D are non-limiting, exemplary illustrations of an embodiment of an apparatus in accordance with the present invention;

FIG. 5 is non-limiting, exemplary illustrations of an embodiment of an apparatus in accordance with the present invention;

FIGS. 6A to 6C are non-limiting, exemplary illustrations of an embodiment of an apparatus in accordance with the present invention;

FIG. 7 is non-limiting, exemplary illustrations of an embodiment of an apparatus in accordance with the present invention;

FIG. 8 is non-limiting, exemplary illustrations of an embodiment of an apparatus in accordance with the present invention; and

FIG. 9 is non-limiting, exemplary illustration of an embodiment of an apparatus in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

Throughout the disclosure, any references to any human anatomy are meant as an illustrative, convenient example for discussion purposes only. That is, the use and application of the various embodiments of the apparatus of the present invention should not be limited to humans but may also be applicable and used in animals, non-limiting examples of which may include dogs, cats, etc.

In the description given below and the corresponding set of drawing figures, when it is necessary to distinguish the various members, elements, sections/portions, components, parts, or any other aspects (functional or otherwise) or features of a device(s) or method(s) from each other, the description and the corresponding drawing figures may follow reference numbers with a small alphabet character such as (for example) “plate 100a, 100b, etc.” If the description is common to all of the various members, elements, sections/portions, components, parts, or any other aspects (functional or otherwise) or features of a device(s) or method(s) such as, for example, to all plates 100a, 100b, etc., then they may simply be referred to with reference number only and with no alphabet character such as, for example, “plate 100.”

The present invention provides an apparatus that may be used with dental implants, non-limiting examples of which are conventional and well-known root-shape intraosseous dental implants. The apparatus of the present invention increases a surface area experiencing exerted forces (functional or parafunctional) to reduce parafunctional stress on the dental implant, while using various dental implant sizes, and without necessitating an increase in dental implant size for stability. Further, the apparatus of the present invention in combination with the use of existing conventional dental implants facilitates and supports osseointegration within an implantation site, including mechanical transfer and transmitting of functional pressures to the installation site of the dental implant in order to avoid disadvantageous restructuring of the bone in adherence to Wolff's law. Further, the use of existing conventional dental implants (small or large) and their respective kits (e.g., surgical implantation tools) with the apparatus of the present invention is universally applicable at the implantation site on the mandible or the maxilla even with substantial bone resorption and without requiring much, if any, osteosynthesis.

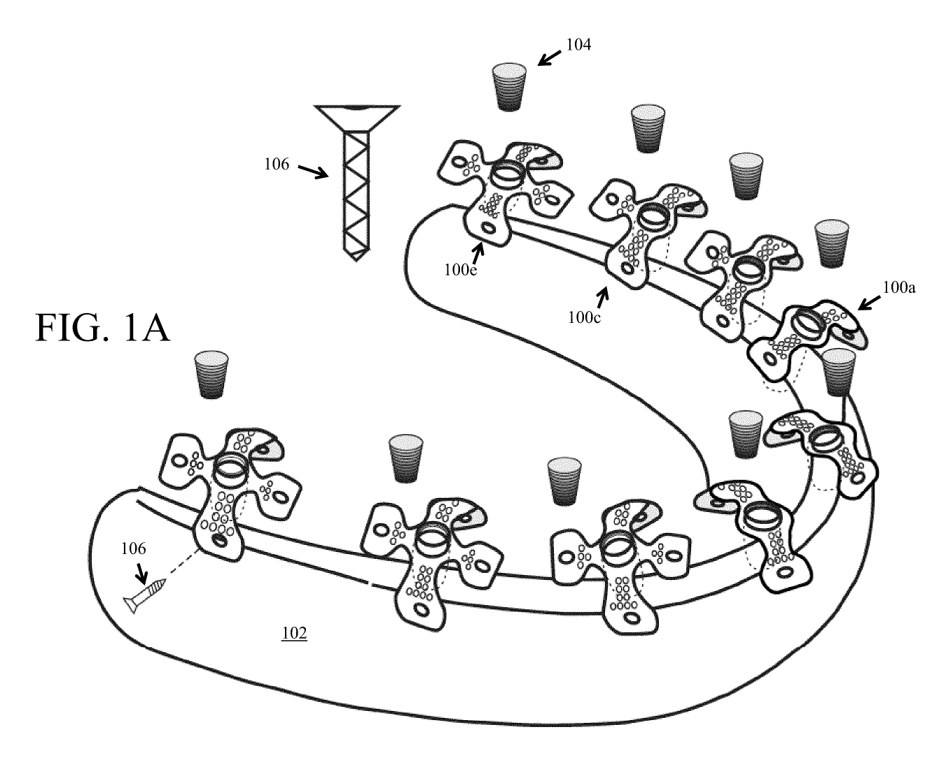

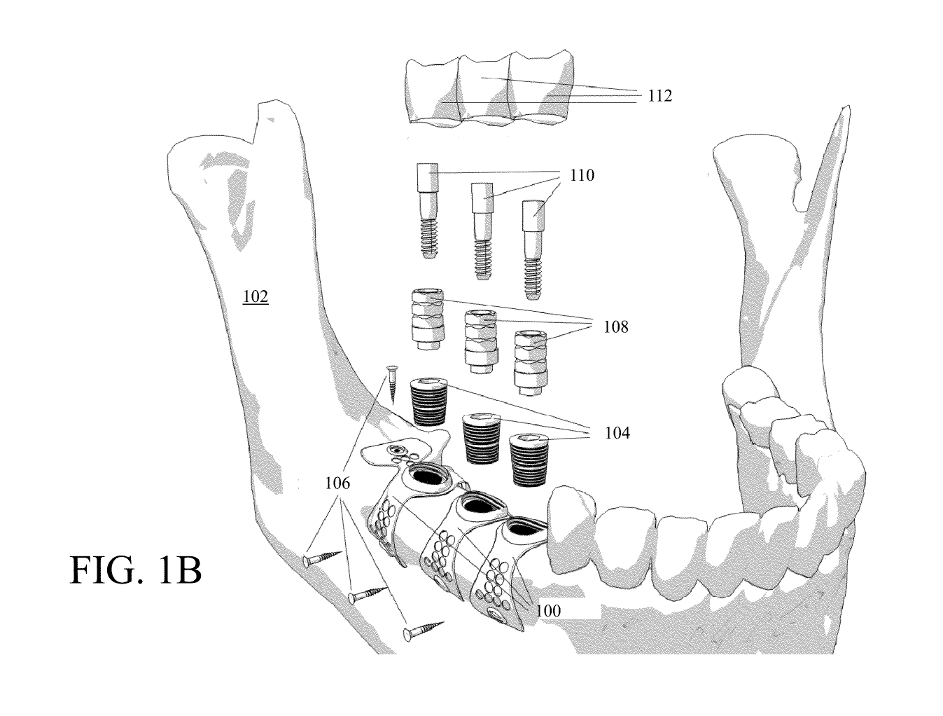

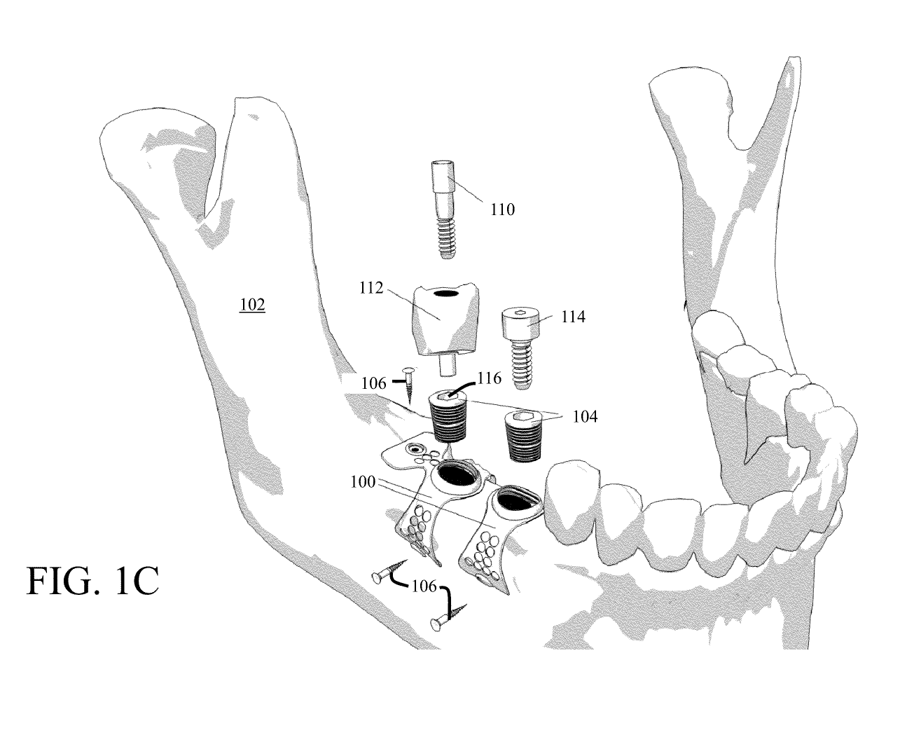

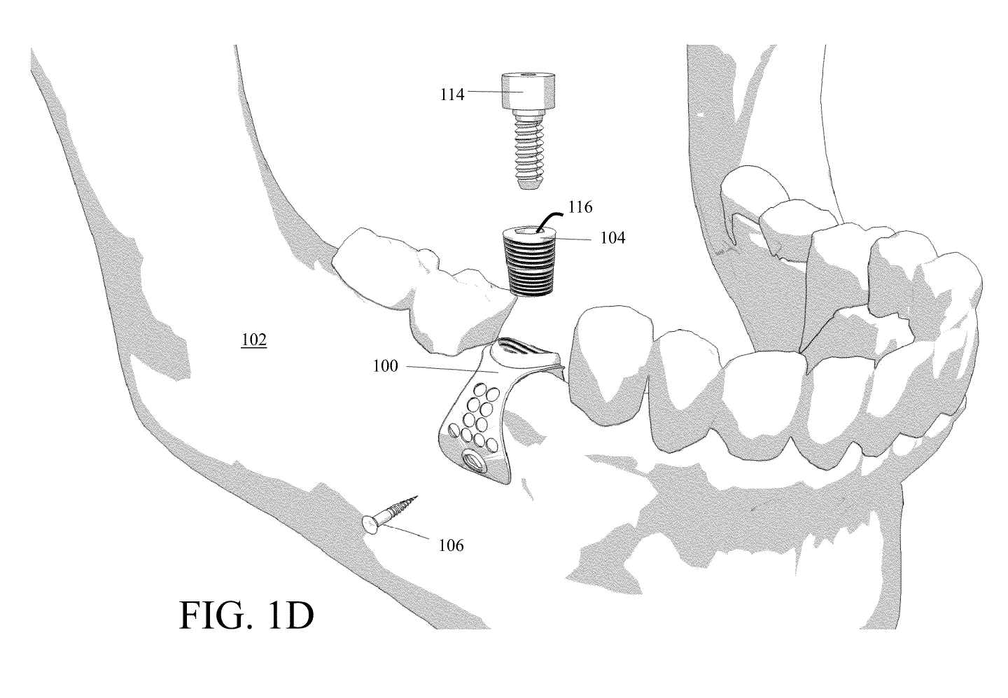

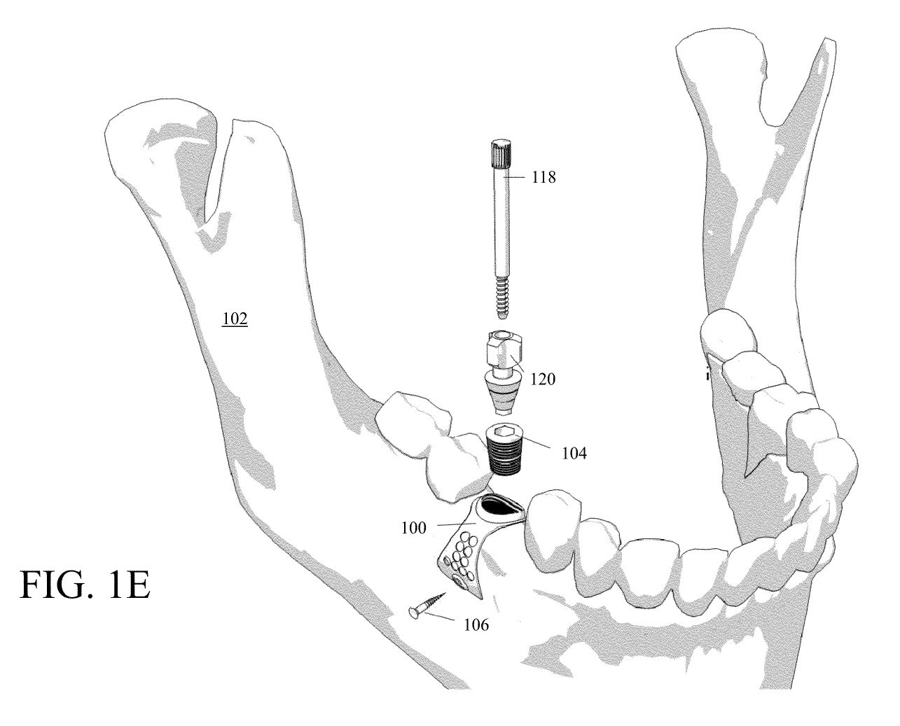

FIG. 1A is a non-limiting, exemplary overview illustration of one or more embodiments of an apparatus of the present invention with one or more conventional intraosseous dental implant fixtures, illustrating universal applicability of one or more embodiments of the present invention at various implantation sites on a jawbone (mandible or the maxilla). As illustrated, the present invention provides an apparatus in a form of a non-limiting, exemplary preferred embodiment of a plate 100 (e.g. plates 100a, 100c, and 100e), which forms a basis, foundation, or an anchoring support on upper or lower jawbone 102 accommodating a non-limiting, exemplary root-shape intraosseous dental implant fixture 104 to form a strong, stable load bearing support that reduces parafunctional stress on the implantation fixture 104 and the implantation site 102, preventing resorption of bone at the implantation site.

FIGS. 1B to 1E are non-limiting, non-exhaustive, exemplary illustrations of various intraosseous dental implant procedures that may be practiced in accordance with one or more embodiments of the apparatus of the present invention. As illustrated in FIGS. 1B to 1E, any known intraosseous dental implant procedure may be continued to be practiced with the use of any one or more embodiments of the plates 100 of the present invention. That is, once the plates 100 are associated with the implantation site 102 (e.g., by using the fasteners 106), and the fixtures 104 are associated with the plates 100 in accordance with one or more embodiments of the present invention, the procedures for which are detailed below, the remaining operational procedures for intraosseous dental implant may be practiced in any well-known and conventional manner. For example, FIG. 1B is a non-limiting exemplary illustration of an intraosseous dental implant procedure that use abutments 108 along with clinical fasteners 110 to associate a prosthetic tooth 112 with implant fixtures 104, which fixtures 104 have previously been secured to installed plates 100 on jawbone 102. As another example, FIG. 1C is a non-limiting exemplary illustration of an intraosseous dental implant procedure that does not use abutments 108, instead using a healing fastener 114 that are commonly used in most intraosseous dental implant procedures. As best illustrated in FIG. 1D, in general, healing fasteners 114 temporarily close off an axial opening 116 of the fixture 104 to block and prevent food or other material from entering inside the fixture's opening 116 while allowing the gingival or the gum to heal prior to further work. As yet another example, FIG. 1E is a non-limiting exemplary illustration of an intraosseous dental implant procedure that uses an impression coping components, comprised of fastener 118 and impression coping analog 120, for generating a mold of a prosthetic tooth 112 to be associated with the fixture 104. Accordingly, once the plates 100 and the fixtures 104 are associated with the desired implantation site 102 in accordance with one or more embodiments of the present invention, the remaining operational procedures for intraosseous dental implant may be practiced in well known and conventional manner.

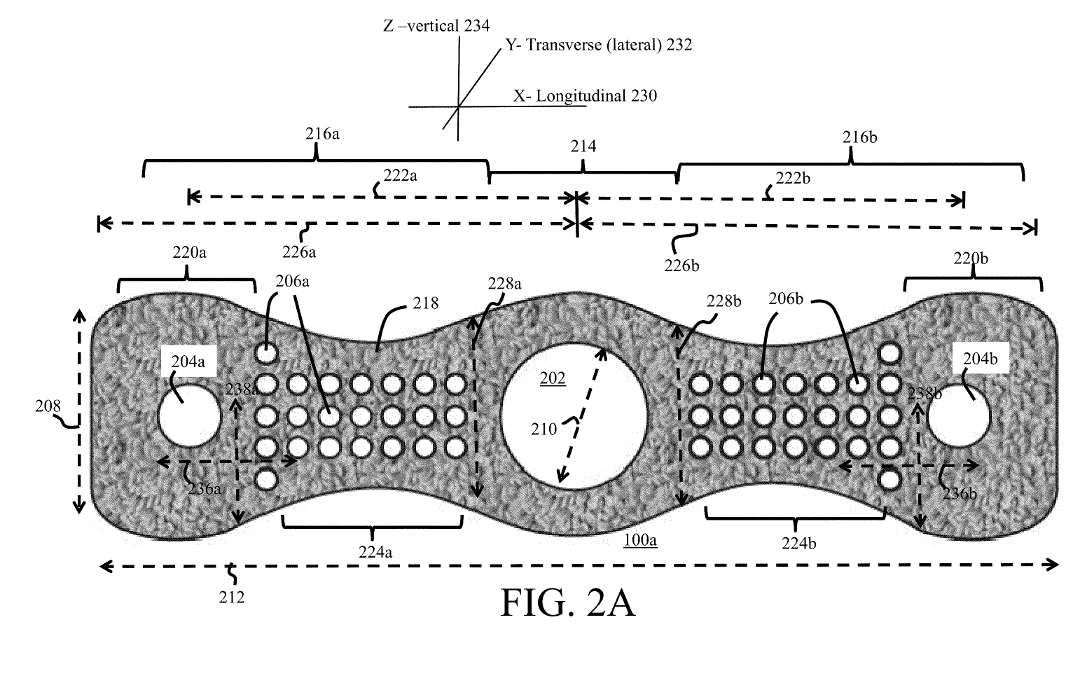

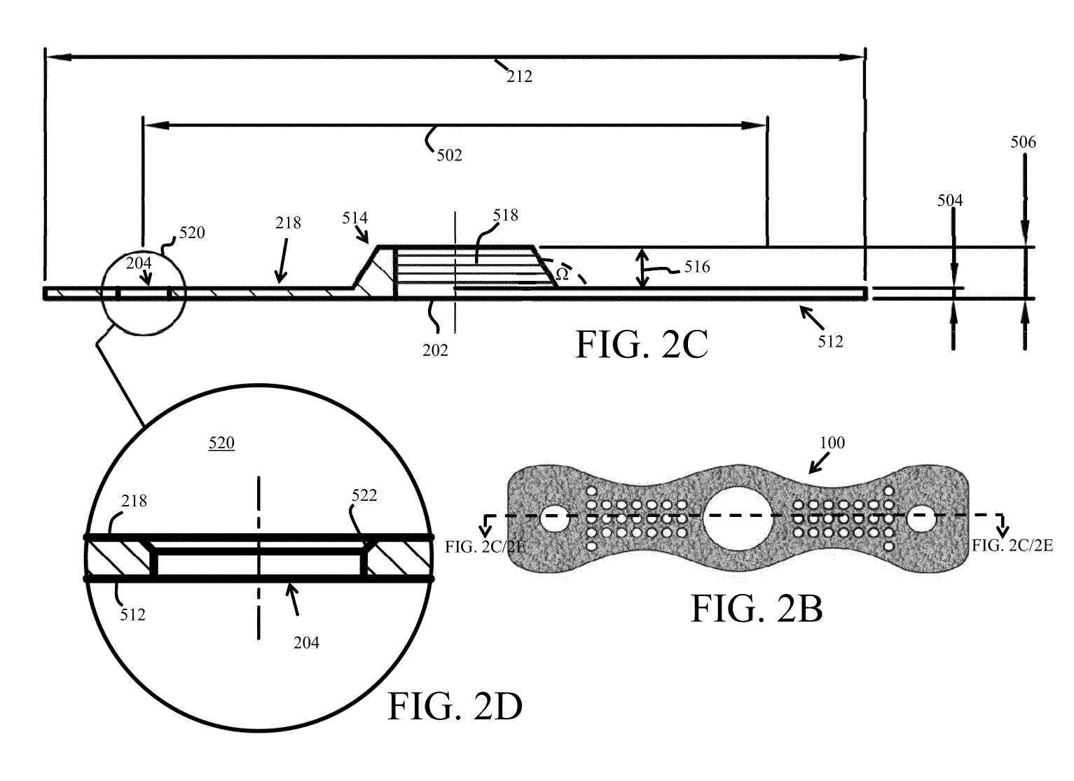

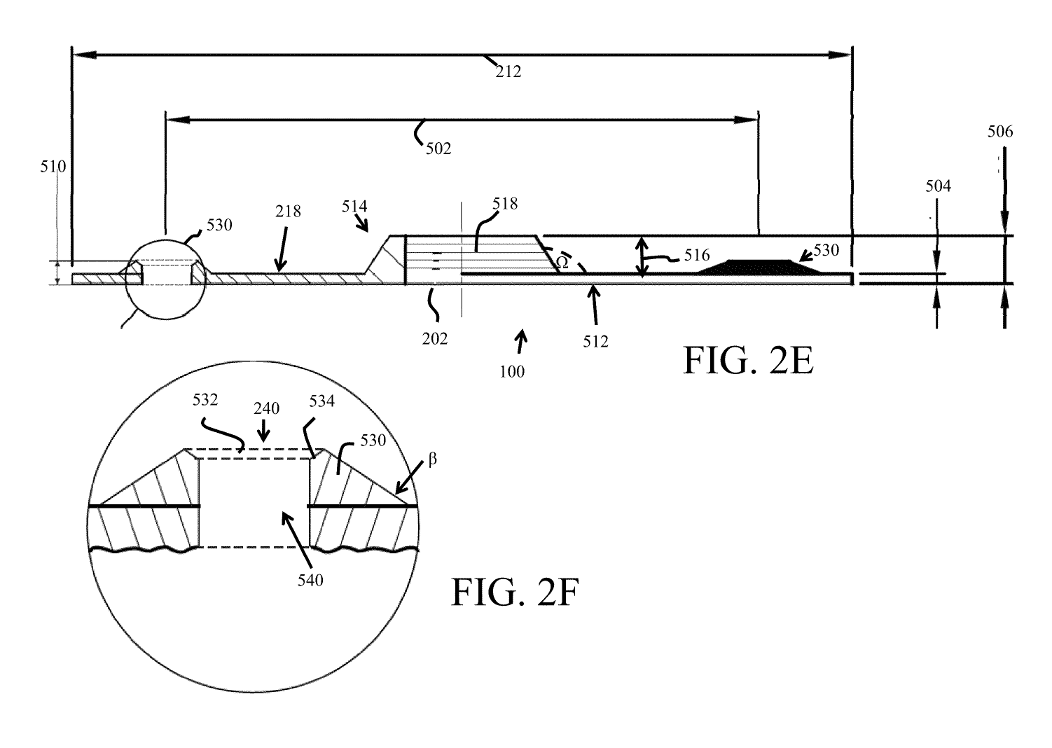

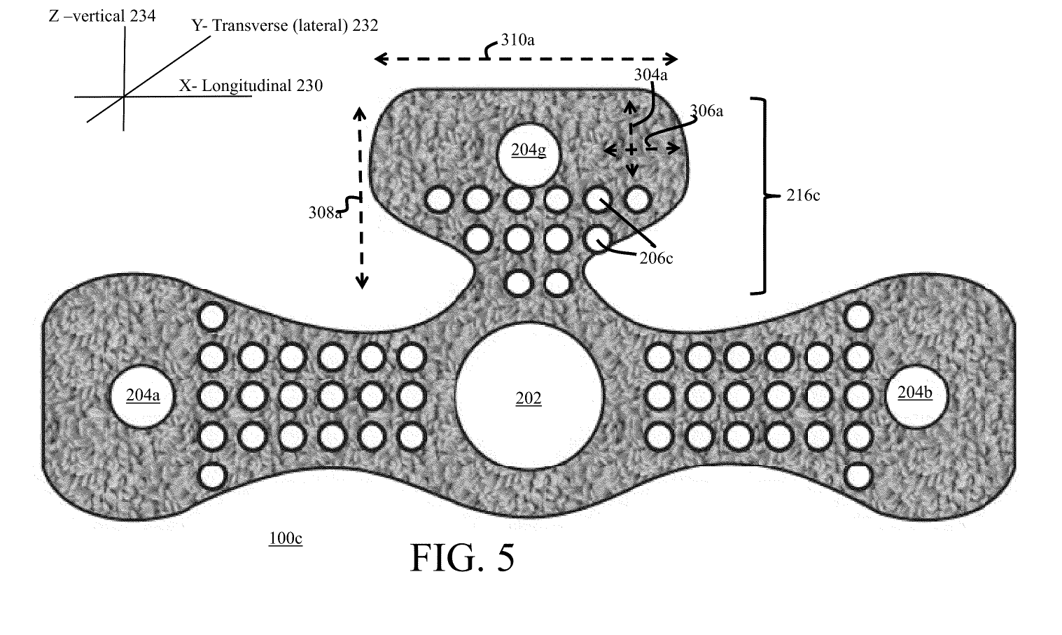

FIG. 2A is a non-limiting, exemplary illustration of an embodiment of an apparatus in accordance with the present invention. As illustrated, the present invention provides an apparatus in a form of a non-limiting, exemplary preferred embodiment of a plate 100a that has an upper side 218 and lower side 512 (FIG. 5A). The plate 100a includes a hole (or fixture hole) 202 for coupling a device such as a cortical thread part of dental implant's fixture 104 with the plate 100a, and one or more apertures (fastener apertures) 204 for securing the plate 100a with the mandible or the maxilla 102. The plate 100a further includes one or more orifices (integration orifices) 206 for integration of the plate with the bone (e.g., osseointegration with the implantation site 102 on the mandible or the maxilla).

As further illustrated, the apparatus of the present invention includes a single piece plate 100a comprised of a central region 214 that accommodates the hole (fixture hole) 202 from which extend first and second connection sections 216a and 216b of the plate 100a, forming a dual plate 100a. The connection sections 216a and 216b are comprised of mesh sections 224a and 224b (detailed below) and distal sections 220a and 220b. Therefore, connection sections 216a and 216b have corresponding apertures 204a and 204b in the distal sections 220a and 220b to receive and securely maintain fasteners 106, e.g. small titanium self-tapping screws (FIGS. 1A to 1E) to connect the plate 100a to bone 102; and each connection section 216a and 216b has orifices 206a and 206b to allow more efficient and effective osseointegration.

Additionally, as indicated above, the one or more fastener apertures 204 are at approximate distal sections 220a and 220b of the connection sections 216a and 216b of the plate 100a, away from the fixture hole 202. The distal sections 220a provide wider body expanse or area around the fastener apertures 204a and 204b for increased anchoring base for added structural integrity for anchoring and support. In one or more embodiments, fixture hole 202 has a first distance 222a from the one or more fastener apertures 204a, and a second distance 222b from the other one of one or more fastener apertures 204b, with the first and second distances 222a and 222b preferably being equal The one or more integration orifices 206a and 206b are positioned between the fixture hole 202 and the one or more fastener apertures 204a and 204b, forming the sections 224a and 224b.

The plate 100a has a plate longitudinal axis 230 and a plate transverse axis 232, with a plate axial length 212 parallel that of the plate longitudinal axis 230 and a plate transverse width 208 parallel that of the plate transverse axis 232. The axial length 212 of the plate 100a is longer than the transverse width 208 to enable connection sections 216a and 216b to connect with the buccal and lingual sections of the implantation site 102. As indicated above, plate 100a includes central region 214 that accommodates fixture hole 202, from which radially extend connection sections 216a and 216b of plate 100a. As best illustrated in FIG. 1A to 1E, connection sections 216a and 216b of plate 100a are adapted to be coupled with buccal and lingual sections of bone 102.

The radially extending connection sections 216a and 216b of plate 100a also include a sectional longitudinal axis 236a and 236b and a sectional transverse axis 238a and 238b. Sectional axial lengths 226a and 226b of connection sections 216a and 216b are parallel sectional longitudinal axis 236a and 236b of connection section 216a and 216b, and sectional transverse widths 228a and 228b of connection section 216a and 216b are parallel sectional transverse axis 238a and 238b of connection section 216a and 216b.

Sectional transverse widths 228a and 228b of connection sections 216a and 216b vary (along sectional longitudinal axis 236a and 236b) from a proximal section of connection section 216a and 216b near hole 202 (near the central region 214) to respective distal sections 220a and 220b, forming a curved silhouette of a radially extending connection section 216a and 216b as illustrated. This provides more material near central region 214 and distal sections 220a and 220b for added strength and improved structural integrity for accommodating fixture 104 and fasteners 106. At the same time, the narrower sections (generally indicated at 224) reduce the amount of material and reduce cost of manufacturing the plates 100. It should be noted that in this non-limiting, exemplary instance, at least one sectional longitudinal axis 236a and 236b of at least one radially extending connection section 216a and 216b is parallel to that of plate longitudinal axis 230 (and hence, the plate axial length 212). Further, in this non-limiting, exemplary instance, at least one sectional transverse axis 238a and 238b of at least one radially extending connection section 216a and 216b is parallel to that of plate transverse axis 232 (and hence, the plate transverse width 208).

FIG. 2B to 2F are non-limiting, exemplary sectional profile illustrations of an embodiment (e.g., shown in FIGS. 2A and 2B) of an apparatus in accordance with the present invention. As illustrated, plate 100 has a general thickness 504, and a total height 506. The upper side 218 of plate 100 includes a raised portion 514 with a non-limiting, exemplary height 516 of about 0.01 mm to about 3 mm or higher (in one non-limiting, exemplary embodiment the height 516 is between about 1.0 mm to about 2.0 mm) on upper side 218 surrounding fixture hole 202. The raised portion 514 is a protuberance that protrudes from upper side 218 at an angle Ω of about 90° to about 160° degrees (in one non-limiting, exemplary embodiment the angle Ω is between about 120° to about 140° degrees) and configured substantially as a frustum. The protuberance 514 continues to define hole 202 there through at a diameter commensurate with that of the cortical connection portion (upper part) of the intraosseous dental implant fixture 104 and is coaxial with the fixture hole 202. The conventional intraosseous dental implant fixture 104 requires fixture hole 202 sizes of about 2.0 mm to about 7.0 mm. Protuberance 514 includes a mechanism for coupling intraosseous dental implant fixture 104 with plate 100. In this non-limiting exemplary instance, the mechanism for receiving and securing the intraosseous dental implant fixture 104 is an interior threading 518. It should be noted that threading 518 extends around the outer wall defining fixture hole 202. In other words, protuberance 514 and fixture hole 202 include a mutually extending threading 518 traversing both. Thus, threaded fixture hole 202 is projected for coupling with the cortical thread part of intraosseous dental implant fixture 104.

Upper side 218 of plate 100 may include recessed portions 520 (e.g., countersinks and or counter-bores) formed from beveled edges 522 on the upper side 218 surrounding the interior surface of one or more fastener apertures 204 to enable coupling of fasteners 106 (e.g., screw's head) flush with upper side 218. The recessed fastener aperture 204 on the surfaces of connection sections 216 allow them to be secured to jawbone 102 by small titanium fasteners 106 so that connection sections 216 and fastener heads are flush. Optionally, connection sections 216 may also provided with punch grooves to ensure proper bending and correct sealing with jawbone 102. Further, the general plate sizes are projected in a way to have standard relation with neighboring teeth or implants.

As illustrated in FIGS. 2E and 2F, apertures 204 may also comprise a raised portion 530 on upper side 218 surrounding fastener aperture 204 (instead of recessed 520 as shown in FIGS. 2C and 2D). The raised portion 530 is a fastener protuberance that protrudes from upper side 218 at an angle β and is configured substantially as a frustum, with upper plane 532 of the frustum having beveled periphery 534 to enable the fastener head to be flush with the plane of the top of the frustum. Fastener protuberance 530 is coaxial with and extends fastener aperture 204 on the body of the plate 100. It should be noted thickness 504 of plate 100 may be varied without affecting aperture 204's function.

In general, surface of plate 100 and fasteners 106 are modified to enhance an facilitate direct structural and functional connection between the bone and the plate/screws. That is, plate 100 and fastener 106 are processed through well known methods, also used commonly for conventional intraosseous dental implant fixture 104, to significantly improve osseointegration, non-limiting examples of such well known methods may include sandblasting, etching, hydroxylapatite coating, etc. Non-limiting examples of material of the plate/fasteners may include Titanium, Aluminum, Vanadium or combinations of alloys thereof such as Ti-6Al-4V. In other words, the material and processing methods of the plates/screws are similar to those used to manufacture and process existing root-shape intraosseous dental implants, which techniques improve osseointegration.

As specific non-limiting examples, in order to improve Bone-Plate Contact (BPC), the surfaces of plate 100 may be treated with well known and conventional sandblasting and acid-etching techniques. To obtain the best possible results in osseointegration, particles of TiO₂, or hydroxyapetite (HA) with non-limiting, exemplary sizes of about 2.5 μm to about 50 μm in diameter may be used as sandblasting material. After sandblasting, acid-etching with either oxalic, hydrochloric HCl, sulfuric acid H₂ SO₄, or other suitable material may be used to smooth the irregular, full of sharp tips rough surfaces (caused by sandblasting) and to remove any embedded sandblast particles. The embedded particles and possible polluting matters, e.g. sandblast particles, are also thoroughly removed by acid etching, resulting in drastic reduction in the Ti corrosive rate. Acid-etching modification further creates numerous secondary micropores (with a non-limiting, exemplary preferred embodiment of about 2.0 μm diameter) on the basis of sandblasted surface macrotexture. The well-known methodologies of sandblasting and surface treatment using acid etching are feasible, reliable, and do not decrease the biocompatibility of titanium. Thus, owing to surface roughness and numerous micropores and embedded HA particles, the surface area of the plate 100 is increased up to 90% or more, which contributes highly to efficient osseointegration and reduces required osseointegration time. It should be noted that other methods of HA coating, such as the use of nano-sized particles is possible.

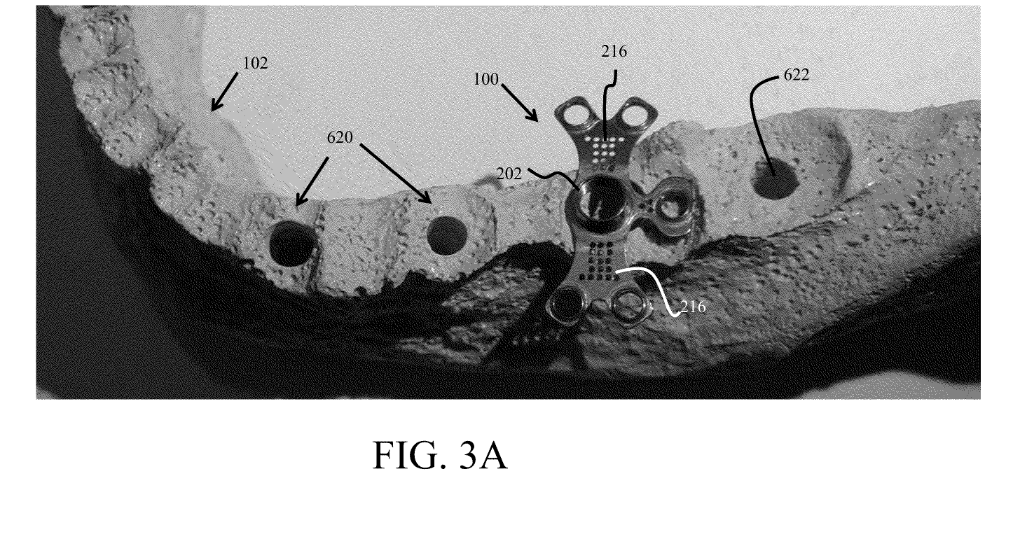

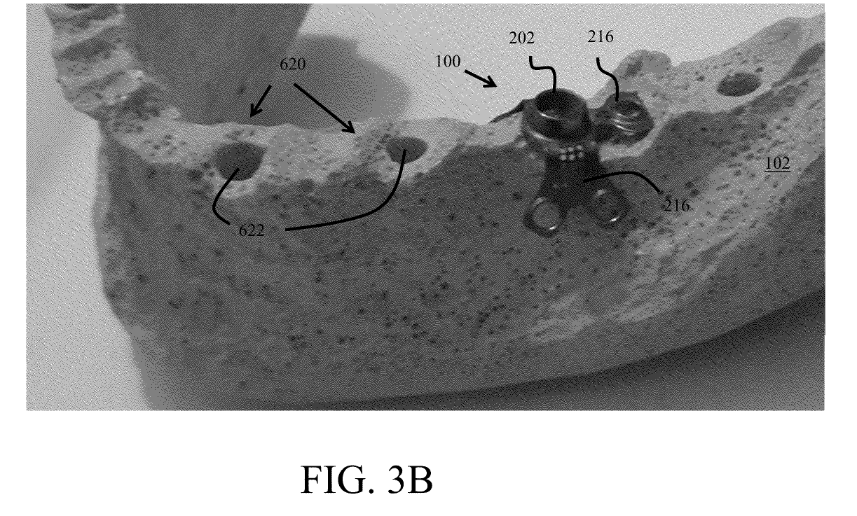

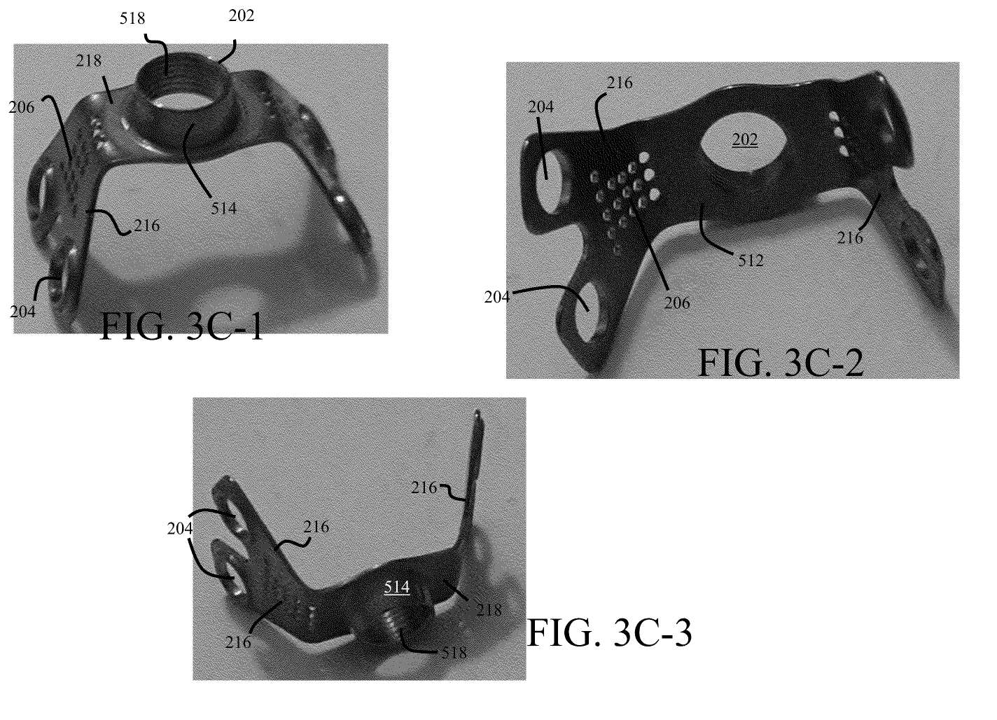

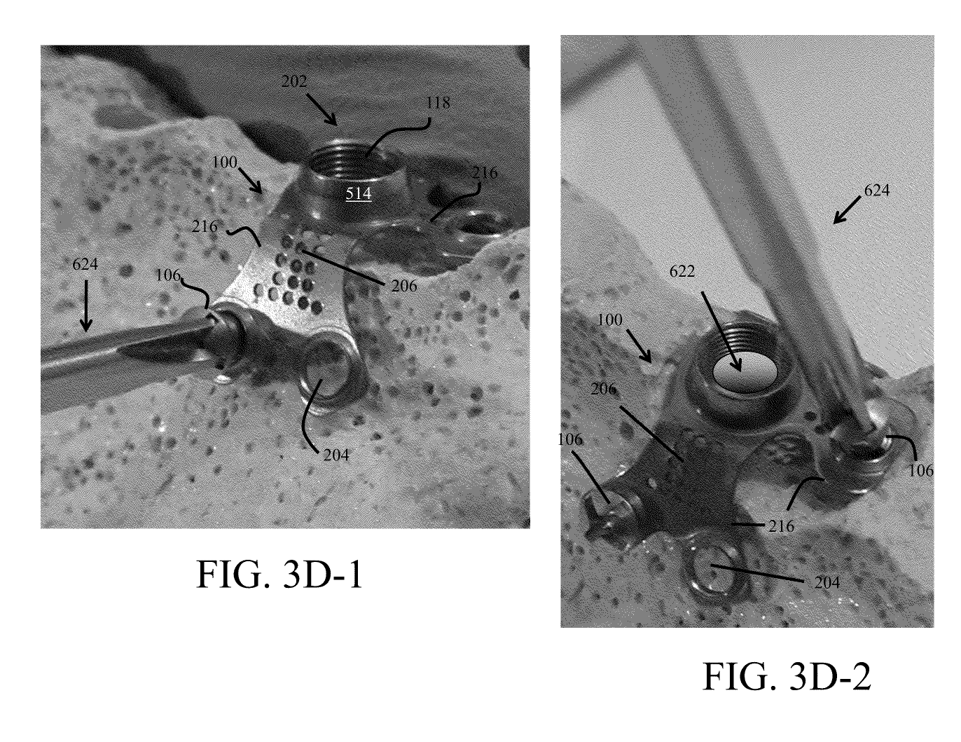

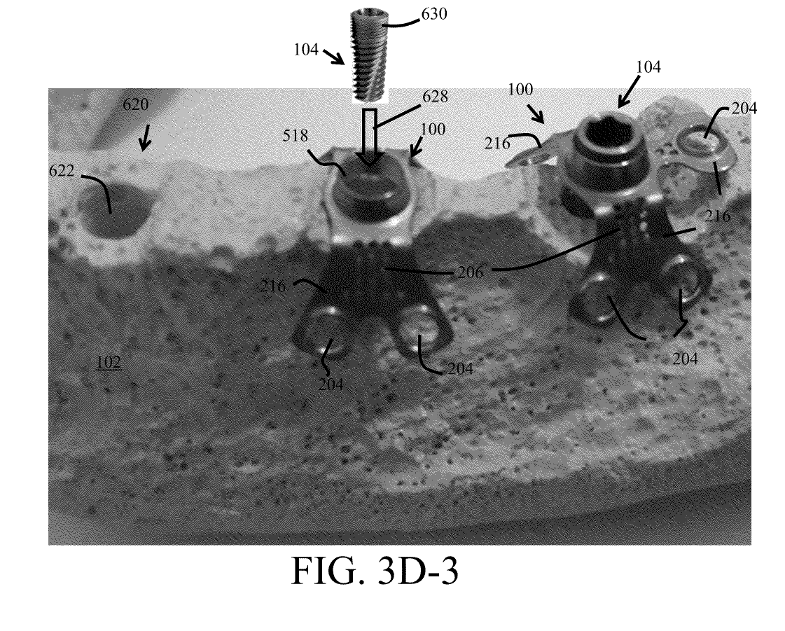

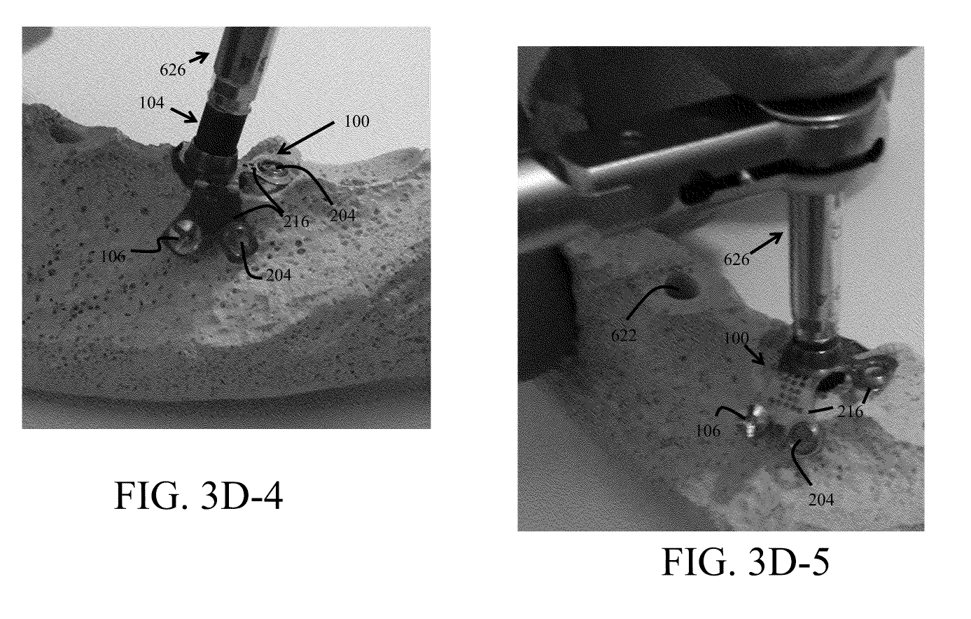

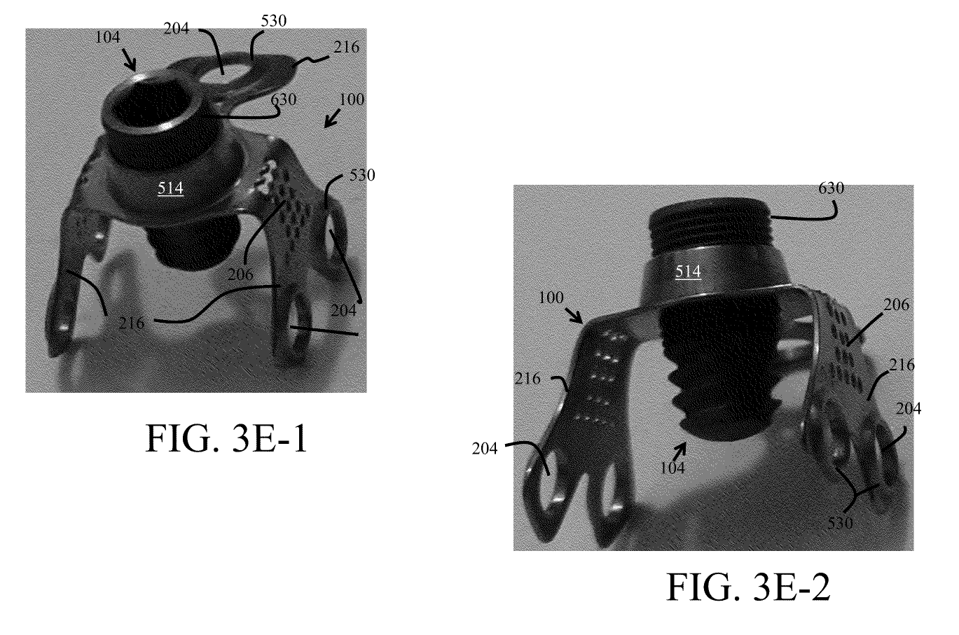

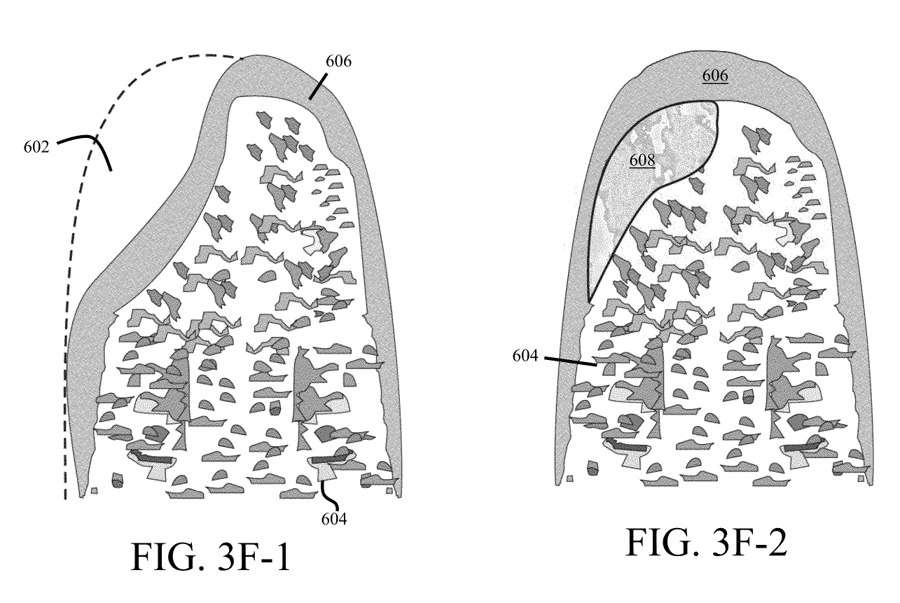

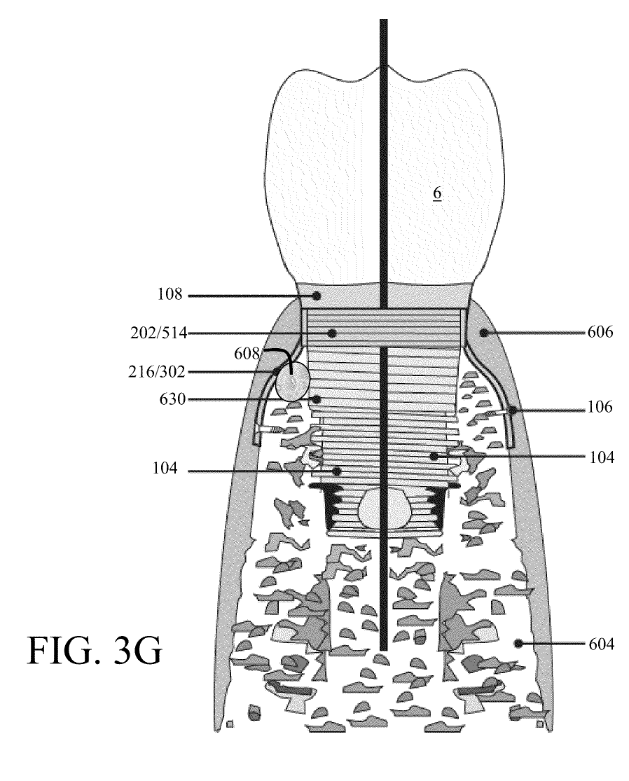

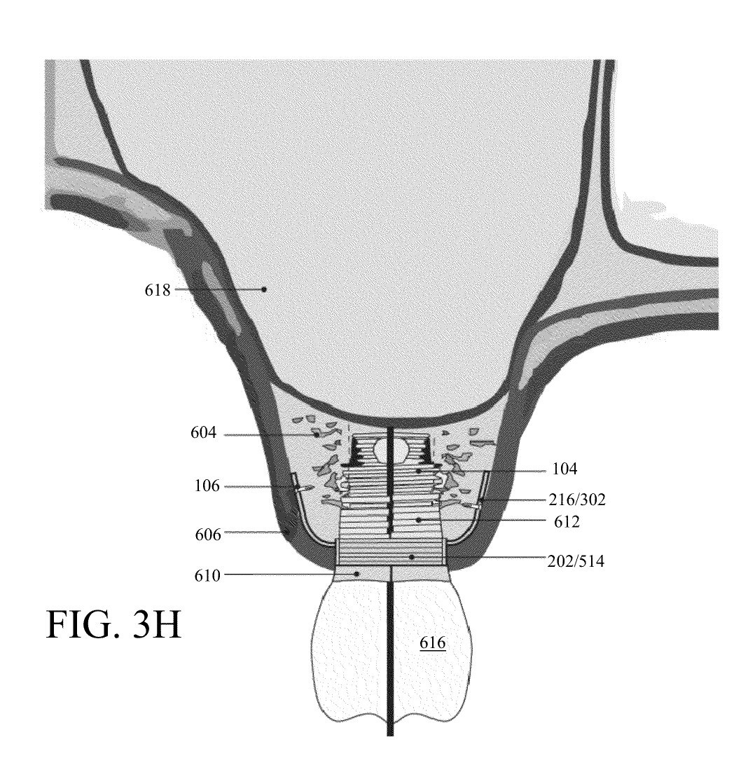

FIGS. 3A to 3H are non-limiting, exemplary illustrations that progressively illustrate associating a plate with an implantation site in accordance with one or more embodiments of the present invention. As illustrated in FIG. 3A, plate 100 is adapted to be associated with specifically desired implantation site 620 on a mandible or a maxilla, or simply jawbone 102. Accordingly, as with conventional surgical procedures, after a decision is made with respect to the actual implantation site(s), direct access is provided to the jawbone 102 by an incision along the crest portion of the gingiva tissue (the gum) to sever and separate the gum for opening access to the jawbone 102. Thereafter, using conventional tools (such as a conventional dental drill), implant cavities 622 are drilled into the crest of jawbone 102 at implantation sites 620 in well-known conventional manner for accommodating intraosseous dental implant fixtures 104.

As further illustrated in FIGS. 3A and 3B, with implant cavities 622 prepared, plate 100 is positioned onto the bone, with the drilled implant cavity 622 aligned with hole 202 of plate 100, and connection sections 216 (best illustrated in FIG. 3B-1) are bent towards the buccal and lingual sections of jawbone 102. FIGS. 3C-1 to 3C-3 are non-limiting, exemplary illustrations of various views of a bent plate 100 in accordance with one or more embodiments of the present invention.

As best illustrated in FIGS. 3D-1 and 3D-2, plates 100 are bent and repositioned on jawbone 102 such that drilled implant cavity 622 aligns with hole 202, with bent connection sections 216 abutting against the buccal and lingual sections of jawbone 102. Upon correct positioning of plates 100, fasteners 106 attach to anchoring apertures 204 and are tightened (using the appropriate tool 624) for anchoring plate 100 along the buccal and lingual sections of jawbone 102. In the non-limiting, exemplary instance illustrated in FIGS. 3D-1 and 3D-2, an embodiment of plate 100 is shown that also includes a third connection section 216 (detailed below) that is secured to the crest of jawbone 102.

FIGS. 3D-3 to 3D-5 are non-limiting, exemplary illustrations that progressively illustrate associating intraosseous dental implant fixture 104 with plate 100 already fixed onto an implantation site 620 in accordance with one or more embodiments of the present invention. As illustrated, the coupling of intraosseous dental implant fixtures 101 with plate 100 is carried out using conventional procedures and tools (such as the illustrated dental fixture wrench 626 best shown in FIGS. 3D-4 and 3D-5). As indicated above, protuberance 514 of plate 100 includes a mechanism for coupling the intraosseous dental implant fixture 104 with plate 100. In this non-limiting exemplary instance, the mechanism is an interior threading 518 for receiving (in the direction of the arrow indicated as 628) and securing the intraosseous dental implant fixture 104. In other words, threaded fixture hole 202 is projected for coupling with cortical thread part 630 of intraosseous dental implant fixture 104 and tightened within plate 100 and into jawbone 102 using dental wrench 626 as illustrated in FIGS. 3D-4 and 3D-5, and FIG. 3D-3 showing the finally secured intraosseous dental implant fixture 104. FIGS. 3E-1 and 3E-2 are non-limiting, exemplary illustrations of an embodiment of a plate with an assembled intraosseous dental implant fixture 104, showing the entirety of the intraosseous dental implant fixture 104 in relation to plate 100 in accordance with one or more embodiments of the present invention. As illustrated, the intraosseous dental implant fixture 104 is not modified, which is used in a well-known conventional manner with preexisting tooling 626.

FIGS. 3F-1 is a non-limiting exemplary illustration of an implantation site on mandible/maxilla with crestal bone resorption 602, including healthy bone 604 and gum tissues 606. FIG. 3F-2 is a non-limiting exemplary illustration of osteosynthesis using well known-methods and material 608 of resorped bone area 602 shown in FIG. 3F-1. FIG. 3G is a non-limiting exemplary illustration of a conventional intraosseous dental implant using an embodiment of plate 100 in accordance with the present invention on the implantation site illustrated in FIG. 3F-2. As illustrated in FIG. 3G, any conventional intraosseous root shaped dental implant may be used with any of the plates 100 of the present invention. In general, the intraosseous root shaped dental implant is comprised of a body fixture 104 that is inserted through threaded fixture hole 202 through the protruded or raised portion 514 of the plate 100, and secured to plate 100 by threading the threaded cortical top portion 630 with the threading 518. The dental implant further includes the crown 616, which may optionally be secured to implant fixture 104 by an abutment 108 and its screw. Accordingly, FIGS. 3F-1 to 3G are exemplary illustrations of use of the present invention with minor osteosynthesis of the bone.

FIG. 3H is a non-limiting exemplary illustration of a conventional dental implant with a shorter fixture (shank) 104 using an embodiment of an apparatus in accordance with the present invention on an implantation site with sever sinus bone resorption 604 (under the sinus 618), but without osteosynthesis or a sinus lift. As illustrated, due to the protuberance 514 of plate 100, a shorter implant fixture 104 may be used without requiring complex osteosynthesis or sinus lift, and without a loss in implant functionality.

Accordingly, due to its novel and unobvious design, plate 100 creates all required and necessary conditions to use conventional intraosseal root-shaped implant fixtures 104, allowing the following:
In a majority of instances, there is no need for additional operations or procedures. That is, no major osteosynthesis (such as sinus lift, etc.) is required in areas with bone resorption because the plate strength alone is sufficient and compensates for lack of bone mass.
Implant loading period is reduced and hastens recovery (as no major operation for osteosynthesis is performed).
Occlusal pressure on crestal edge is reduced due to distribution of lateral threes by plate 100.
Crestal bone part resorption is reduced due to proper distribution of forces.
Crown ratio becomes smaller (root part extension) due to protuberance surrounding the fixture hole 202, because the protuberance surrounding the hole 202 provides for a more sturdy and rigid engagement and the length of the implant fixture 104 used may be shorter.
Lateral forces are distributed in different directions and upon a larger surface created by plate 102, thus reducing lateral force destructive effect.
Resistance increase against bruxism, clenching, tongue thrust and other parafunctional forces.
The possibility of fracture of fixture is reduced to almost zero because protuberance 514 of about 2 mm surrounding fixture hole 202 encloses cortical section 630 of fixture 104, with the rest of the fixture (shank) secured within the bone 102. In other words, the upper part of fixture 104 (the 3 to 5 mm), which is the cortical thread 630, will remain intact because it is securely maintained within the 2 mm titanium protuberance 514 of plate 100.
Possibility of abutment screw loosening decreases. The movement of the abutment is due to minor micro-movements of the upper portion (cortical section 630—top 2 to 3 mm) of fixture 104 itself within bone 102. Those micro-movements are reduced when cortical section 630 of implant 104 is secured within protuberance 514 of plate 100 while supporting plate 100 and implant fixture 104 together are osseointegrated within bone 102.
Cervical area hygiene is improved due to plate's special design because connection section 216 of plate 100 is continuous and prevents and blocks material from entering through cervical area. The cervical area may for example have receded due to bone resorption. That is, even if there is a resorption at or near the cervical area, the body of plate 100, including connection section 216, will continue to protect the underlying anatomy by blocking any food or other particles from entering the resorped area.
Implant migration is prevented due to anchoring and osseointegration of plate 100 and its support for implant fixture 104.
Periimplantitis possibility is reduced because no infection can occur near the implantation due to improved hygiene. Center region 214 of plate 100 near fixture hole 202 allows easy cleaning around implantation site 622, and facilitates cleaning of any settled particles.
No additional extensive training is required to use plates 100 as any conventional intraosseous dental implant 104 may be used with plate 100.

As best illustrated in FIG. 3H, plate 100 of the present invention enables the use of a shorter root length of the implantation commensurate with the height of the protuberance 514 (e.g., one non-limiting, exemplary preferred embodiment of which may comprise about 1 mm to about 2 mm). Accordingly, plate 100 of the present invention enables the use of a shorter dental implant (illustrated in FIG. 3H) on implantation sites with severe bone resorption. For example, if an approximate ratio for normal implant is 2:1 (2 root to 1 crown), the shorter implant used with plate 100 may include a ratio of 1:2 (1 root to 2 crown). Therefore, shorter intraosseous dental implants may be used where there is insufficient bone mass to support an implant with root to crown ratio of 2:1. Titanium plate 100 enables the use of shorter implants due to the raised protrusion 514, which in anon-limiting, exemplary preferred embodiment is about 1 mm to about 2 mm, thereby making the shorter intraosseous dental implant even stronger than normal implants despite reduced shank. The 2 mm of titanium (the non-limiting, exemplary preferred height of the protuberance 514) is the equivalent of having about 10 mm depth of bone structure, which exceeds the bone's needed proper anchoring and support. The use of plate 100 enables implantation of shorter fixtures 104 in as low or lower than 3 to 4 mm of bone structure 604 (FIG. 3H).

Being installed in the necessary area by bending connection sections 216 to correspond to the mentioned area jawbone external form, plate 100 is fixed by using apertures 204 projected for small titanium screws, afterwards, fixture hole area drilling and implant installation is conducted (as detailed above so that the fixture's cortical thread 630 upper 1.5 mm to 2 mm are in fixture hole 202 of plate 100 and the remaining part of fixture 104 (the shank) in jawbone 102. As necessary, a free space (e.g., 602) between plate 100 and jawbones 102 can be filled with bone material 608 (FIGS. 3F-1 and 3F-2). Masticating pressures are passed onto jawbone 102 and at the same time due to the plate's novel design lateral and parafunctional pressures are distributed upon the whole surface of plate 100, including connection sections 216. Consequently, concentrated stress and destructive effects are reduced.

It should be noted that the use of plates 100 eliminates the need for conventional meshes (not shown) to temporarily hold and maintain bone material 608 fixated at a position (if bone material 608 is to be used). Plates 100 function to lift and maintain the gingiva tissue 606 at a level higher than jawbone 102, creating a volume of space underneath and within which the bone material 608 remains confined. Plates 100 act like pillars that maintain gum 606 above jawbone 102 and create a permanent volume of space within which bone martial 608 is positioned without it being depressed by gum 606 pressures. This allows bone material 608 time to harden. The prior art used a mesh structure (not shown) to create the permanent volume of space, but that mesh structure is removed after bone material 608 has been cured within gum 606, which is a second surgical procedure. With the present invention, there is no mesh structure to remove because plates 100 are a permanent part of the implant itself and will permanently maintain the space defining the bone material.

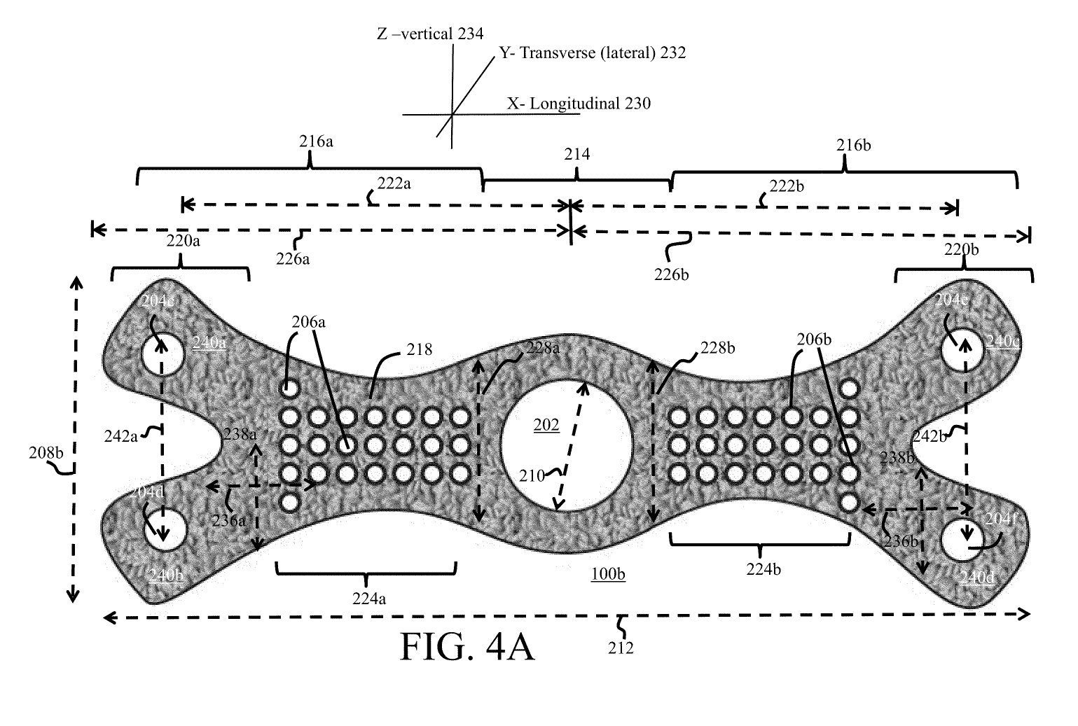

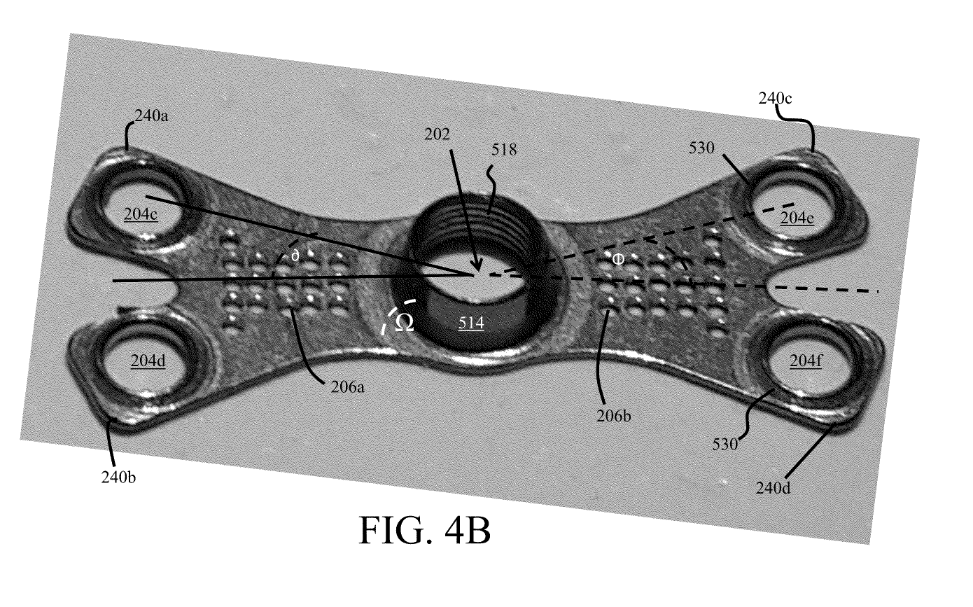

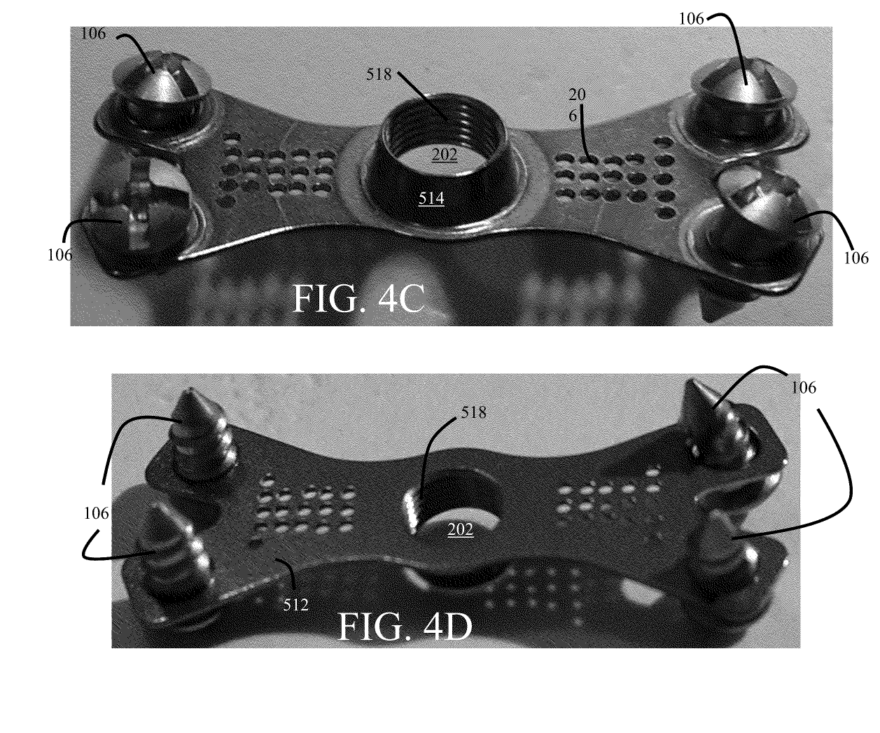

FIGS. 4A to 4D are non-limiting, exemplary illustrations of an embodiment of an apparatus in accordance with the present invention. Plate 100b illustrated in FIGS. 4A to 4D includes similar corresponding or equivalent components, interconnections, functional, and or cooperative relationships as plate 100a that is shown in FIGS. 1A to 3H, and described above. Therefore, for the sake of brevity, clarity, convenience, and to avoid duplication, the general description of FIGS. 4A to 4D will not repeat every corresponding or equivalent component, interconnections, functional, and or cooperative relationships that has already been described above in relation to apparatus 100a as shown in FIGS. 1A to 3H.

As illustrated in FIG. 4A to 4D, a non-limiting, exemplary preferred embodiment of the apparatus with a plate 100b with bifurcated distal sections 220a and 220b is provided. The reason for the use of bifurcated branching of apertures 204 along distal sections 220a and 220b of connection sections 216a and 216b is if bone loss exists, the inserted ends of fasteners 106 will not come into contact with the lower portion of the intraosseous dental implant fixture 104. The bifurcated branches 240 of distal sections 220a and 220b guide fastener 106 insertions away from the intraosseous dental implant fixture 104 rather than directly towards it. This is partly due to bifurcated branches 240 having an angle Φ (illustrated in FIG. 4B) in relation to the center of first hole 202. Further, bifurcated branches 240 add separation distance 242 between apertures 204 to provide a wider span, base, or foundation for improved stability and anchoring of plate 100b.

As best illustrated in FIG. 4B, it should be noted that each bifurcated branch 240a, 240b, 240c, and or 240d may have different positional, angular, distal, and orientational relation to one another and or in relation to fixture hole 202. For example, bifurcated branch 240a with its aperture 204c may be positioned at a further distance from and at an angle of to fixture hole 202 compared with the rest of branches 240b, 240c, and or 240d. As another example, the angular and distal positions of bifurcated branches 240a and 240d may be identical in relation to fixture hole 202, but different from bifurcated branches 240c and 240b. Accordingly, various combinations and permutations of different positional, angular, distal, and orientational relation of each bifurcated branch 240a, 240b, 240c, and 240d with respect to each other and or the first hole 202 are possible. FIG. 4C is a non-limiting, exemplary illustration of a first side of apparatus 100b with fasteners 106 associated with the apertures 204, and FIG. 4D illustrates the same but showing the second side. As illustrated in FIG. 4D, second side 512 of plate 100 (all plates) is substantially flat, but has a textured surface as described above for improved ossiointegration.

FIG. 5 provides non-limiting, exemplary illustrations of an embodiment of an apparatus in accordance with the present invention. Plate 100c illustrated in FIG. 5 includes similar corresponding or equivalent components, interconnections, functional, and or cooperative relationships as plates 100a and 100b that are shown in FIGS. 1A to 4D, and described above. Therefore, for the sake of brevity, clarity, convenience, and to avoid duplication, the general description of FIG. 5 will not repeat every corresponding or equivalent component, interconnections, functional, and or cooperative relationships that has already been described above in relation to plates 100a and 100b that is shown in FIGS. 1A to 4D.

FIG. 5 illustrates a non-limiting, exemplary preferred embodiment of the invention with a plate 100c comprised of a central region 214 that accommodates fixture hole 202 from which radially extend connection sections 216, forming a triple connection plate 100c. Plate 100c includes an additional connection section 216c, which itself may be secured on a crest of the jawbone 102 (FIG. 3D-2). In this embodiment, at least one sectional longitudinal axis 236 of at least one radially extending connection section 216 parallel that of plate longitudinal axis 230 and at least one sectional longitudinal axis 304a of at least one radially extending connection section 216c parallel that of plate transverse axis 232. Third connection section 216c is shorter in length 308a and may be wider in width 310a compared with length 226 and width 228 of the wing sections 216 and is for connection with the crestal bone area of jawbone 102. Further, positional, angular, distal, and orientation of aperture 204g with respect to the reset of plate 100c body, including apertures 204a and 204b and or fixture hole 202 may be varied.

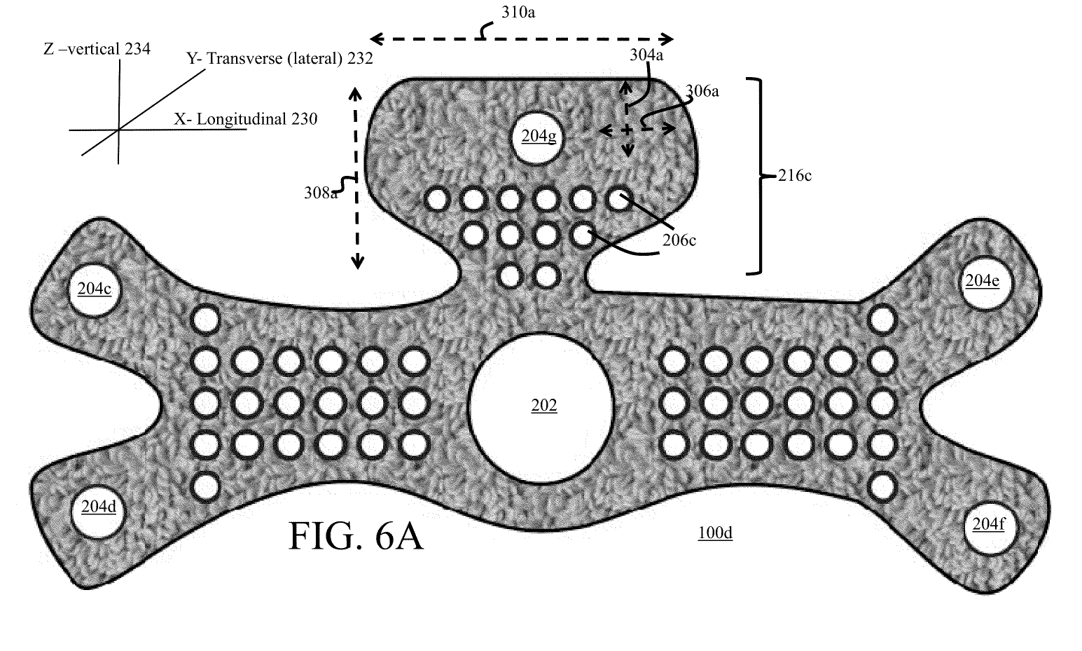

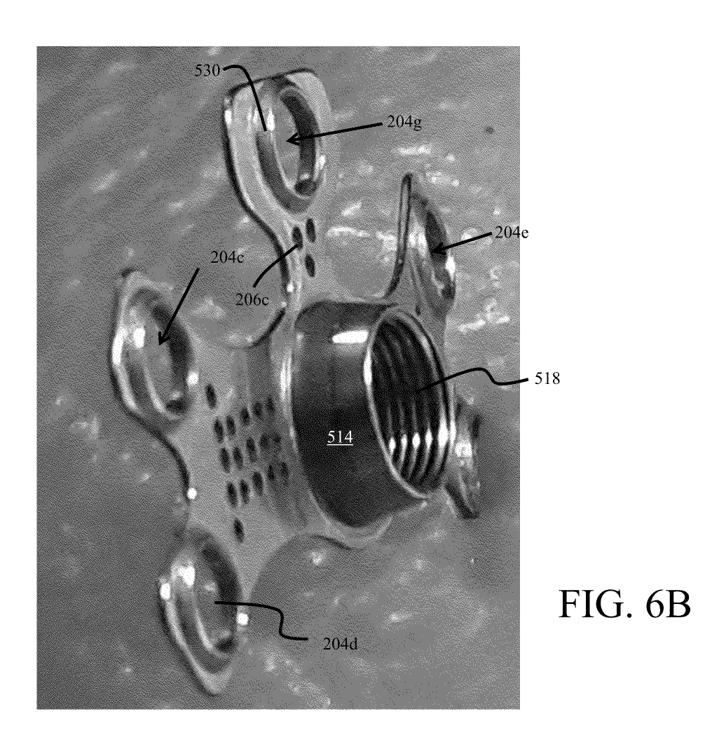

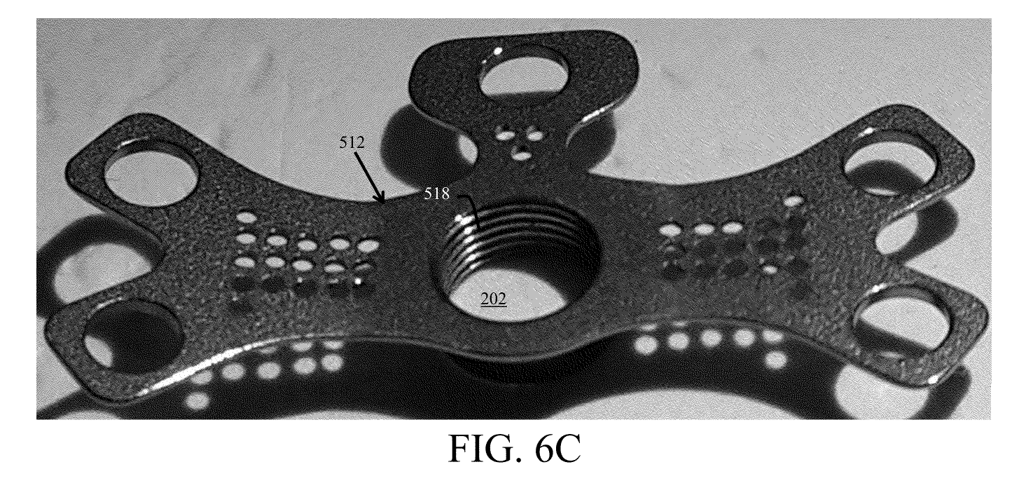

FIGS. 6A to 6C are non-limiting, exemplary illustrations of an embodiment of an apparatus in accordance with the present invention. Plate 100d illustrated in FIGS. 6A to 6C includes similar corresponding or equivalent components, interconnections, functional, and or cooperative relationships as plates 100a, 100b, and 100c that are shown in FIGS. 1A to 5, and described above. Therefore, for the sake of brevity, clarity, convenience, and to avoid duplication, the general description of FIGS. 6A to 6C will not repeat every corresponding or equivalent component, interconnections, functional, and or cooperative relationships that has already been described above in relation to plates 100a, 100b, and 100c that are shown in FIGS. 1A to 5. As illustrated in FIGS. 6A to 6C, the present invention provides an apparatus in a form of a non-limiting, exemplary preferred embodiment of a plate 100d (which is a combination of plates 100b and 100c). In this embodiment, in addition to the third connection section 216c as in plate 100c, distal sections 220a and 220b of plates 100d are bifurcated.

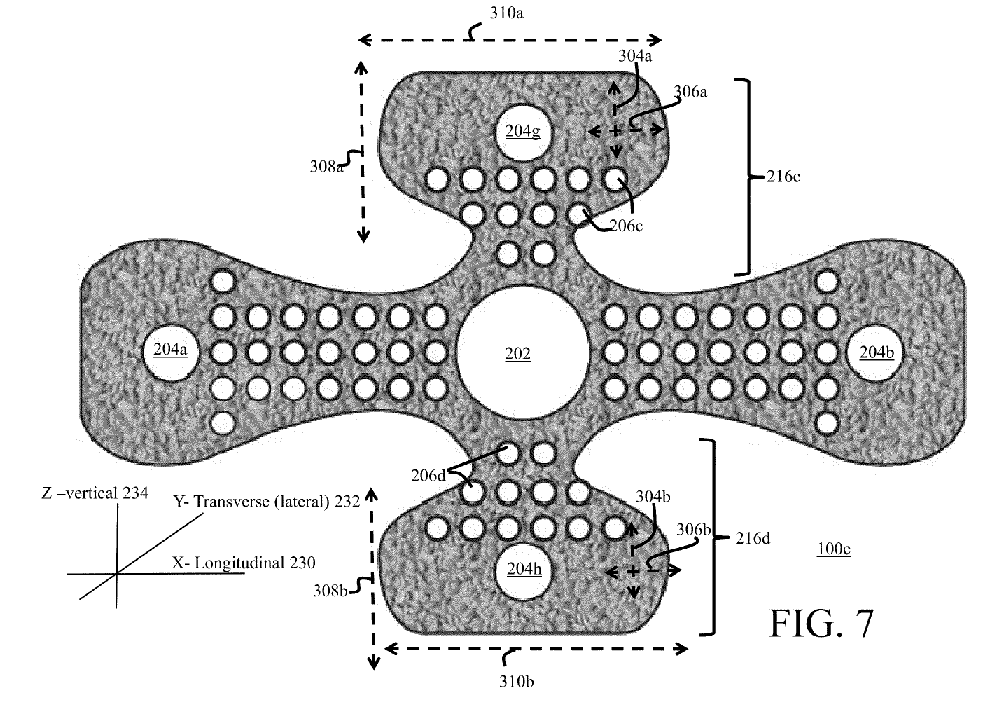

FIG. 7 is non-limiting, exemplary illustrations of an embodiment of an apparatus in accordance with the present invention. Plate 100e illustrated in FIG. 7 includes similar corresponding or equivalent components, interconnections, functional, and or cooperative relationships as the apparatuses 100a, 100b, 100c, and 100d that are shown in FIGS. 1A to 6C, and described above. Therefore, for the sake of brevity, clarity, convenience, and to avoid duplication, the general description of FIG. 7 will not repeat every corresponding or equivalent component, interconnections, functional, and or cooperative relationships that has already been described above in relation to apparatuses 100a, 100b, 100c, and 100d that are shown in FIGS. 1A to 6C. As illustrated. in FIG. 7, the present invention provides an apparatus in a form of a non-limiting, exemplary preferred embodiment of a plate 100e (which is a combination of plates 100a and 100c), but with an additional connection section 216d. The positional, angular, distal, and orientation of second hole 204h with respect to the reset of plate 100e, including apertures 204a, 204b, 204g, and or fixture hole 202 may be varied. As with section 216c, connection section 216d may also be used for connection with the crestal bone area of jawbone 102.

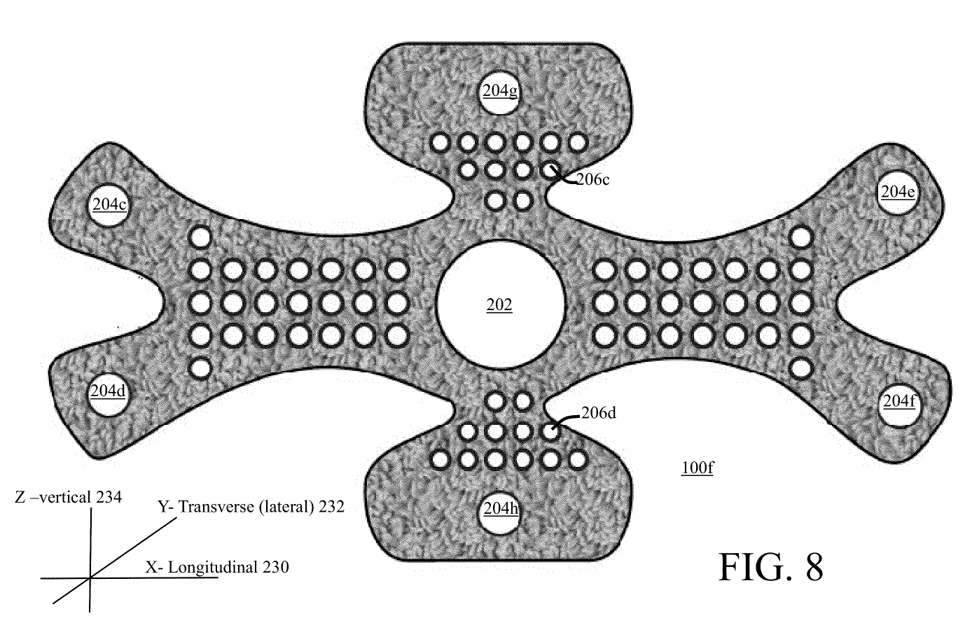

FIG. 8 is non-limiting, exemplary illustrations of an embodiment of an apparatus in accordance with the present invention. Plate 100f illustrated in FIG. 8 includes similar corresponding or equivalent components, interconnections, functional, and or cooperative relationships as plates 100a, 100b, 100c, 100d, and 100e that are shown in FIGS. 1A to 7, and described above. Therefore, for the sake of brevity, clarity, convenience, and to avoid duplication, the general description of FIG. 8 will not repeat every corresponding or equivalent component, interconnections, functional, and or cooperative relationships that has already been described above in relation to plates 100a, 100b, 100c, 100d, and 100e that are shown in FIGS. 1A to 7. As illustrated in FIG. 8, the present invention provides an apparatus in a form of a non-limiting, exemplary preferred embodiment of a plate 100f (similar to that of plate 100e in FIG. 7), but with bifurcated distal sections along connection sections 216a and 216b. The number of connection sections 216 should not be limited to the four shown and can be increased, but four is preferred due to the small size of the component.

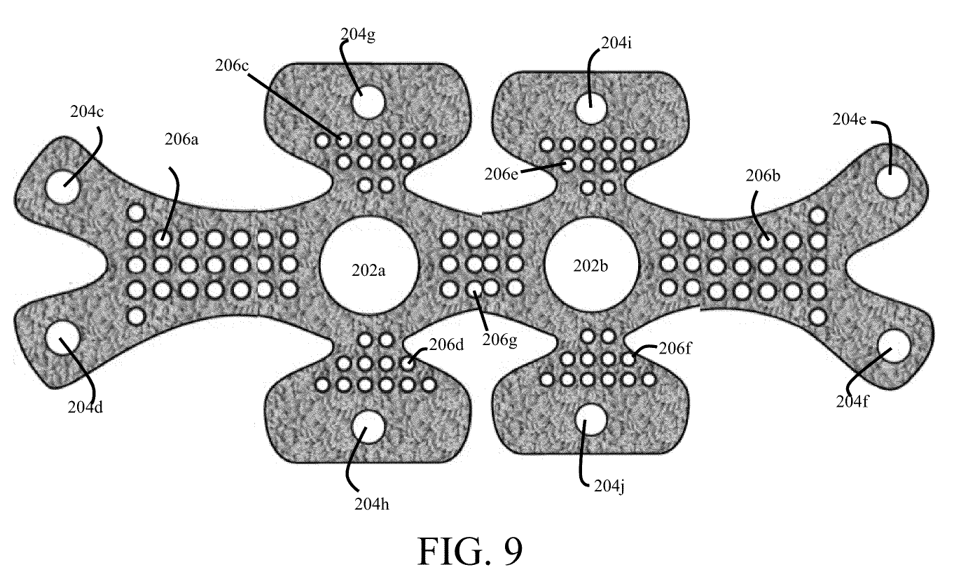

FIG. 9 is non-limiting, exemplary illustration of an embodiment of an apparatus in accordance with the present invention. Plate 100g illustrated in FIG. 9 includes similar corresponding or equivalent components, interconnections, functional, and or cooperative relationships as plates 100a, 100b, 1100c, 100d, 100e, and 100f that are shown in FIGS. 1A to 8, and described above. Therefore, for the sake of brevity, clarity, convenience, and to avoid duplication, the general description of FIG. 9 will not repeat every corresponding or equivalent component, interconnections, functional, and or cooperative relationships that has already been described above in relation to plates 100a, 100b, 100c, 100d, 100e, and 100f. that are shown in FIGS. 1A to 8. As illustrated in FIG. 9, the present invention provides an apparatus in a form of a non-limiting, exemplary preferred embodiment of a plate 100g that includes two fixture holes 202a and 202b, including additional connection sections 216.

Accordingly, the present invention provides non-limiting, exemplary preferred embodiments, such as double, triple, and quadruple formations (with or without bifurcated Y-shape or split ends or branches), with the use of each depending on a number of implants, installation position and the type of fixture (the dental implant portion within the bone or the shaft or the shank part of the dental implant) used.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, all the measurements disclosed may be varied, the illustrated bifurcated distal ends of the wings need not be equal in dimension to one another, and may be varied. As yet another example, fixture hole 202 may or may not be equally distanced from any of the one or more fastener apertures 204. As a further example, the mechanism (e.g., threading 518) to secure an intraosseous dental implant fixture 104 need not be a thread and in fact, may be modified to be commensurately compatible with a corresponding securing arrangement of an intraosseous dental implant fixture 104. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. An implant apparatus, comprising:
a plate with a first and second sides that includes:
at least one hole for coupling a device with the plate;
at least one aperture for securing the plate with a bone; and
at least one orifice for integration of the plate with the bone.

2. The apparatus as set forth in claim 1, wherein:
a raised portion is defined on the first side surrounding the hole, the raised portion defining a mechanism for coupling the device securely.

3. The apparatus as set forth in claim 2, wherein:
the raised portion is substantially shaped as a frustum that defines the hole there-through.

4. The apparatus as set forth in claim 2, wherein:
the mechanism is an interior threading for receiving and securing the device.

5. The apparatus as set forth in claim 1, wherein:
the device is an intraosseous root shaped implant, and the bone is an implantation site on a mandible or a maxilla.

6. The apparatus as set forth in claim 1, wherein:
the hole is centrally located on the plate and the aperture is located at a distal section of the plate; and
the at least one orifice is positioned between the hole and the aperture.

7. The apparatus as set forth in claim 1, wherein:
the plate includes a central region that defines the hole, from which radially extend at least a first connection section and a second connection section of the plate in opposing direction.

8. The apparatus as set forth in claim 1, wherein:
a material of the plate is selected from the group comprising: Titanium, Aluminum, Vanadium.

9. The apparatus as set forth in claim 1, wherein:
a material of the plate is selected from the group comprising alloys of: Titanium, Aluminum, Vanadium, forming Ti-6Al-4V.

10. The apparatus as set forth in claim 1, wherein:
the first side of the plate includes:
a recessed portion formed from beveled edges on the first side surrounding the aperture to enable coupling of fasteners flush with the first side.

11. A support apparatus for an intraosseous dental implant, comprising:
a plate affixed to an implantation site of an intraosseous implant on a mandible or a maxilla;
the plate includes:
at least one implant hole for receiving and securing the intraosseous implant;
at least one anchoring aperture for anchoring the plate onto the implantation site;
at least one integration orifice for facilitating and enhancing integration of the plate with the implantation site.

12. The apparatus as set forth in claim 11, wherein:
a plurality of orifices allow for osseointegration of the plate to the mandible or the maxilla.

13. The apparatus as set forth in claim 12, wherein:
a plurality of connection sections are defined by the plate and emanate laterally from the hole;
each connection section having at least one anchoring aperture for receiving a fastener;
wherein, the plate and connection sections increase the surface area for the implant and reduce parafunctional pressures while mechanically transferring and transmitting functional pressures to the implantation site without an increase in size of the intraosseous implant and without osteosynthesis.

14. A method for allowing intraosseous implants in damaged or missing bone tissue of the mandible or maxilla, comprising:
providing a supporting plate for an implantation site;
osseointegrating the supporting plate via a plurality of orifices defined through said plate;
anchoring the plate through at least one connection section defining at least one aperture for receiving a fastener;
providing a hole defined by a threaded wall of predetermined height to securely receive an intraosseous implant therein;
wherein: osseointegrated supporting plate reduces parafunctional pressures experienced at the implantation site while mechanically transferring and transmitting functional pressures to the implantation site without an increase in size of the intraosseous implant and without osteosynthesis thereby preventing further resorption at the implantation site.

15. The method of claim 14, further comprising:
providing a protrusion in a substantially frustum shape as the wall extending above the plate and further defining the hole there-through.
